(19) United States
(12) Patent Application Publication
(10) Pub. No.: US 2016/0311610 A1
(43) Pub. Date: Oct. 27, 2016

(54) PORTION CAPSULE FOR PREPARING A BREWED PRODUCT

(71) Applicant: QBO COFFEE GMBH, Wallisellen (CH)

(72) Inventors: Louis Deuber, Richterswil (CH); Rüdiger Ternité, Hamburg (DE); Ingo Lantz, Hamburg (DE)

(21) Appl. No.: 15/104,430

(22) PCT Filed: Dec. 11, 2014
(86) PCT No.: PCT/EP2014/077363

§ 371 Date: Jun. 14, 2016

(30) Foreign Application Priority Data
Dec. 24, 2013 (EP) 13199517.7

(51) Int. Cl. B65D 85/804; A47J 31/40; A47J 31/36

(52) U.S. Cl. CPC B65D 85/8043; A47J 31/3623; A47J 31/407

(57) ABSTRACT

A portion capsule that is filled with an extraction substance for producing a brewed product, and includes a main part and a cover. The main part has a base region and a peripheral lateral wall. The cover is secured to the main part along a peripheral collar. The collar is connected to the peripheral lateral wall toward a cover side. The main part has a substantially rectangular cross-section in the region of the collar. The cover forms an outward curvature such that the cover contributes to a capsule volume, and the collar is at least 1.6 mm wide.

### BACKGROUND OF THE INVENTION

1. Field of The Invention

The invention relates to the preparation of drinks or likewise, from an extraction material, for example ground coffee, which is contained in a capsule. In particular, it relates to a capsule with an extraction material, as well as a preparation system.

2. Description of Related Art

Extraction appliances for preparing drinks from an extraction material present in a portion package are known, for example, as coffee machines or espresso machines and are enjoying increasing popularity, as was hitherto the case. In many corresponding systems, the portion packages are designed as capsules, in which the extraction material is closed off, for example in an airtight manner. The capsule is pierced at two opposite sides, for the extraction. A brewing fluid—generally hot water—is introduced at the first side. The brewed product is led out of the capsule at the second side. Thereby, a considerable pressure for example of 5-20 bar must prevail in the inside of the capsule—also less for filter coffee, which is to say “American coffee” or tea—depending on the drink to be prepared and the system.

In particular, aluminium and plastics, for example polypropylene have become known as capsule materials. Aluminium capsules provide a very good durability (aroma protection) of the extraction material, but are very energy-costly to manufacture. Polypropylene capsules are advantageous with regard to the energy expense and disposal, but impose increased demands on the piercing mechanism and the aroma protection.

A coffee portion capsule of plastic and which approximately has a cube shape and in contrast to the known beaker-like capsules has no peripheral collar on the plane of the one (upper-side) cover surface is known from WO 2010/118543. Such a peripheral collar is required with capsule systems according to the state of the art, firstly in order to guide the capsule on insertion into the extraction appliance and to hold it in an intermediate position after the insertion. Secondly, the collar is necessary on the plane of the upper-side cover surface, so that the capsule can be sealed by way of clamping in the collar between suitable sealing elements of the extraction appliance on introducing the brewing fluid, so that the brewing fluid which is under pressure cannot flow past the capsule. Thirdly, such a collar is necessary for the closure of the capsule by way of ultrasound welding or thermal sealing by a flat cover (which can also be designed as a foil). A more reliable sealing is obtained with a wider collar, independently of the sealing methods, since the sealing surface is larger. This applies to the closure by way of ultrasound welding, where an energy director must moreover be accommodated on the collar of the capsule, as well as by way of thermal sealing.

In contrast to this, according to WO 2010/118543, an arched cover is used instead of the common cover foils or membranes, and the closure is effected for example by way of ultrasound cut'n' seal. The capsule manufactured according to the teaching of WO 2010/118543 accordingly, independently of its (“cube”) shape, has a welding bead which is peripheral between the planes defined by the cover surface and which forms only a minimal collar.

The capsule according to WO 2010/118543 has significant advantages, which are also described in this document. However, it is a technical challenge to handle the capsule described in WO 2010/118543 in a brewing unit of an extraction appliance, and to ensure the sealing. The essentially cube-shaped plastic capsule bloats at the high temperatures and pressures prevailing during the brewing procedure and changes its shape, which indeed is an effect which is desired for the sealing, as is explained further below. However, it has been found that the capsule tends to approximate a spherical shape given high inner pressures and when the material is sufficiently soft due to the heat, and this shape, amongst other things, compromises the sealing, and in the worst case can also led to a jamming of the capsule in the brewing unit.

It is accordingly an object of the present invention, to further develop capsules of the type described in WO 2010/118543, in order to improve the sealing of the capsule in the brewing unit and further functionalities.

### SUMMARY OF THE INVENTION

According to an aspect of the invention, a capsule of plastic with an extraction material is provided, the capsule includes:

a main body with a bottom region and with a peripheral side wall; and

a cover, which is fastened on the main body;

wherein the cover is fastened on the main body along a peripheral collar, wherein the collar towards a cover side connects to the peripheral side wall;
wherein the main body in the region of the collar has an essentially rectangular cross section;
wherein the cover forms an outward arching, so that the cover contributes to a capsule volume;

and wherein the collar has a width of at least 1.6 mm.

The width of the collar in particular can be between 1.6 and 4 mm.

It has been found that such a capsule meets the initially set demands particularly well. In particular, the problems on sealing could be solved by way of the wider collar. Although capsules with peripheral collars of a width of significantly greater than 1.6 mm are known from capsule systems, which are already obtainable on the market. With regard to these systems, however, it is the case of capsules with a circular or at least approximately round cross section and which are closed by a flat cover membrane, as has already been described. With these capsule systems, an extraction-side sealing is typically achieved by sealing elements in the brewing chamber, which lie on the capsule collar. A sealing on the capsule collar by way of sealing elements, which are integrated into the collar is likewise known. A sealing by way of a rubber-elastic sealing element on the collar of the capsule is described for example in EP1654966A1. The collar with the capsule according to the invention does not assume such a sealing function, but rather the extraction-side sealing takes place at the arched cover. Specifically, the capsule deforms on account of the inner pressure and the high temperature during the brewing procedure, such that the arching of the capsule cover, in particular in the arcuate outer regions, is pressed in an extensive manner against a correspondingly shaped, arcuate and not necessarily elastic sealing surface of the brewing module. The arched cover in its outer regions, however, no longer bears on the respective sealing surfaces of the brewing module in a manner adapted to shape, if the capsule deforms too much in the direction of a sphere, and a reliable sealing is no longer ensured. This effect can be avoided by the wider collar according to the invention, since this collar stiffens the capsule such that it retains its square or rectangular cross section, so that a reliable sealing is effected via the arched cover, which bears on the sealing surfaces within the brewing unit. Thereby, it is significant that the collar is not located in a plane with the capsule surface, but lies below the arching of the cover, in the region of which arching the sealing is effected.

A brewing module with a head with lateral guide means which guide the collar of a capsule of the type taught in WO 2010/118543 on insertion into the brewing module and out of which the collar can be displaced by retrieval means without these lateral guide means having to be movable in lateral directions, is suggested in the not yet published European patent application 13 186 920.8 of Luna Technology Systems LTS GmbH. This type of guidance on interacting with the retrieval means functions particularly advantageously thanks to the shape of the capsule, which is rectangular in the region of the collar, thanks to which the collar is laterally guided along an extended path. Specifically, a guide means can hold the capsule, for example at two locations, which are spaced from one another along the collar, and a retrieval means can centrally engage between these locations, due to the rectangular shape and the possibility of guiding along an extended stretch (path), wherein this is not possible with a rotationally symmetrical capsule. This, for example, also permits the retrieval means to be engaged with the capsule also during the brewing process, and no mechanism is necessary to bring the retrieval means into engagement with the capsule after the brewing process, which is in contrast to solutions of the state of the art. Other types of interaction between the guidance and retrieval means are rendered possible due to the rectangular shape of the capsule together with a collar of the claimed type.

For this reason, the collar, which is more than 1.6 mm wide, can simplify the guiding of the capsule during the insertion, during the brewing process and during the ejection, in particular in a brewing module of the type suggested in the European patent application 13 186 920.8. Thus the three features “rectangular basic shape”, “arching of the cover” and “collar with minimum width” indeed interact with one another in an ideal manner, by way of the guiding during the insertion and during the brewing process and the ejection, as well as the sealing with respect to the brewing module, being solved in a satisfactory manner, without having to forgo the significant advantages of a capsule as is disclosed in WO 2010/118543 (for example, stackability, tight packing ability, etc), and despite the fact that the capsule collar itself even in the specified arrangement as explained above would be less suitable for sealing the capsule in a conventional manner by way of clamping between elastic sealing means of brewing module parts that can be displaced with respect to one another.

In an embodiment, the capsule is designed such that with an overpressure of 1 bar at 95° C. (a typical temperature of the brewing fluid), the diameter in the middle between the bottom (base) and the capsule collar increases by at least 1 mm, in particular by at least 2 mm, in order to improve the sealing. In practise, even greater pressures and higher temperatures, for example above 110° C. can prevail during the brewing procedure, and the increase in volume of the capsule can therefore also lie significantly above the values specified here. This applies to the condition without an encompassing seal, whereby such a seal can prevent such a bloating, depending on the dimensioning. A reliable sealing can also be achieved when the diameter of the capsule in a plane parallel to the peripheral collar is smaller than the inner dimensions of the brewing chamber, on account of this. In particular, manufacturing tolerances can be compensated.

The shape of the capsule, as mentioned, is such that the main body in the region of the collar is essentially rectangular, for example is essentially square in cross section. The collar itself—for example its outer edge—can also be essentially rectangular, in particular square. “Essentially rectangular” or “essentially square” in particular does not exclude rounded corners,

The capsule as a whole—with the exception of the collar and a possible offset of the cover arching, see below—can have the shape of a cube or cuboid, in particular of a cube. In embodiments, the collar can project laterally maximal by 4 mm, in particular maximally by 3 mm, maximally by 2.5 mm or, for example, maximally by 2.2 mm. In particular, a protruding of 1.6 to 2.2 mm is thereby preferred, since it has been found that an optimal compromise between the advantages of an as small as possible collar (stackability of the capsule, compactness of the capsule and thus also of the brewing unit, elegant appearance) and the advantages of a wider collar (better sealing in the brewing unit due to the stiffening effect, simpler and improved sealing on the collar by way of a boarder sealing surface, simpler handling of the capsule when gripping on the collar and/or guiding of the collar in a groove) is achieved here. The cube shape does not rule out an inclination of the peripheral side surfaces to the axis (perpendicular to the bottom surface and/or cover surface) of for example maximal 3°, in particular maximal 2° or maximal 1.5°—which is inherent of the manufacture of capsules manufactured by deep-drawing or injection moulding methods.

With an embodiment essentially with a cube shape, the outer length of the cube edges, for example, is between 24 and 30 mm for a filling quantity of between approx. 6 g and approx. 10 g of coffee. Larger dimensions, for example of up to 35 mm, are not to be ruled out for larger filling quantities.

The main body with the bottom region and the peripheral side wall thus forms a type of beaker that is closed by the cover. Thereby, the bottom region can be flat, but this is not a necessity.

The shape of the cover, from the outside to the inside, can include the cover collar, an arcuate transition region and a middle flat region forming the actual upper-side cover surface. Such a flat region is set away, which is to say shouldered outwards from the plane of the cover collar, on account of the transition region effecting the arching. The transition region, for example, can be curved in an S-shaped manner or run in a constantly curved manner from an outer portion at an angle to the collar plane, towards the middle flat region. The dimensioning is thereby selected such that the middle flat region is optically dominant, for example by way of it being as equally large as or only insignificantly (for example by maximal 10%) smaller than the bottom surface. It is particularly with an embodiment of the capsule, which as a whole is cuboid or cube-shaped, that one can envisage this flat region assuming more than 60% of the diameter and accordingly at least 40% of the surface. This middle flat region simplifies the piercing and thus the extraction.

The cover collar generally forms a peripheral surface that faces the cover side and that extends from an outer edge of the collar up to a base of the arching. In embodiments, one can envisage the base of the arching being offset inwards compared to the portion of the side wall, onto which portion the collar connects. Such an offset for example can be at least 0.2 mm.

The main body as well as the cover are generally manufactured of plastic, for example. In particular, one can envisage the main body and the cover consisting of the same plastic. Polypropylene is mentioned as an example of a material, wherein a barrier layer can be incorporated and this has barrier characteristics for oxygen and prevents a diffusion of oxygen into the capsule. Such a barrier layer, for example, includes an ethylene vinylalcohol copolymer (EVOH). The wall thickness in the region of the main body in particular lies between 0.1 mm to 0.7 mm, preferably between 0.2 mm and 0.4 mm, for example between 0.25 mm and 0.35 mm. The same can also apply to the wall thickness of the cover. In a preferred embodiment, the wall thickness of the cover roughly corresponds to the wall thickness of the main body.

Other plastics are also considered instead of polypropylene. The application of the invention to non-plastics is also not to be ruled out.

The main body can be manufactured with the deep-drawing method. Alternatively, the manufacture by way of injection moulding is also considered. The same applies to the cover, wherein the deep-drawing method can also be considered as an embossing method due to its limited depth. Combinations with an injection moulded main body and a deep-drawn cover and vice versa are possible.

The fastening of the cover on the main body, according to a first embodiment, is effected by way of ultrasound welding. According to a first possibility, the ultrasound cut'n' seal method is applied, with which a possibly projecting edge of the cover and of the main body is also cut or separated away by way of the effect of the ultrasound. According to a second possibility, the separation is effected in a separate machining step, for example by way of punching or by way of ultrasound separation in a separate station.

In an embodiment—and this is an option for both possibilities—an energy director is present on the cover and not on the main body, for the ultrasound welding method. This has been found to be particularly advantageous for the connection between the main body and the cover.

In a second embodiment, the fastening of the cover on the main body is effected by way of heat transfer from a heated tool. In a third embodiment, the fastening is effected by way of laser welding. In a fourth embodiment this is effected by bonding. Here too, the edge can be separated away by different methods (punching, ultrasound separation, etc.)

Combinations, for example with the melting-on of an adhesive by way of ultrasound and/or heat (thus actually a soldering method) or with the use of a heated sonotrode in a combined thermal/ultrasound method etc. are also possible.

A system for preparing a brewed product apart from a capsule of the outlined type also includes a machine (extraction appliance) for preparing the brewed product with the help of such a capsule. The machine, as is known per se, includes a brewing module, by way of which a brewing chamber can be formed, in which brewing chamber the capsule is located during the brewing process. The brewing module has an injector for introducing a brewing fluid—generally under pressure—and a discharge device for discharging this. The injector and/or the discharge device in the manner known per se can include perforation elements for piercing the capsule.

The discharge device is moreover provided with a sealing surface that is matched to the arching or curvature and against which the cover of the capsule inserted into the brewing chamber is pressed by the pressure of the brewing fluid. Such a sealing surface will be at least partly curved, wherein the curvature is matched to the corresponding curvature of the cover, for example in the region between the collar on the one hand and an essentially flat cover surface (in which the capsule can be pierced on the extraction side as the case may be) on the other hand.

The brewing module moreover includes lateral guide means for guiding the collar during the insertion of the capsule into the brewing module. These guide means hold the capsule after its insertion and before closure of the brewing chamber.

The brewing module can be designed such that the capsule is positioned by an insert opening and the guide means such that the cover of the inserted capsule lies on the side of the discharge device. The sealing surface interacts with the capsule cover by way of this, and a possible bloating ability of the previously discussed type can reinforce the sealing effect of an injection-side seal which can form a part of the injector.

### BRIEF DESCRIPTION OF THE DRAWINGS

Embodiment examples of the invention are hereinafter described by way of drawings. In the drawings, the same reference numerals indicate the same or analogous elements. The drawings are not true to scale and may show elements which correspond to one another in sizes which differ from figure to figure. There are shown in:

FIG. 1 a capsule in a lateral view;

FIG. 2 the capsule according to FIG. 1 in an alternative view;

FIG. 3 a sectioned representation of the capsule in the region of the collar;

FIG. 4 a brewing module;

FIG. 5 a view of the discharge device of the brewing module;

FIG. 6 a sectioned view of the brewing module;

FIG. 7 an alternative capsule; and

FIG. 8 a sectioned representation of the capsule according to FIG. 7.

### DETAILED DESCRIPTION OF THE INVENTION

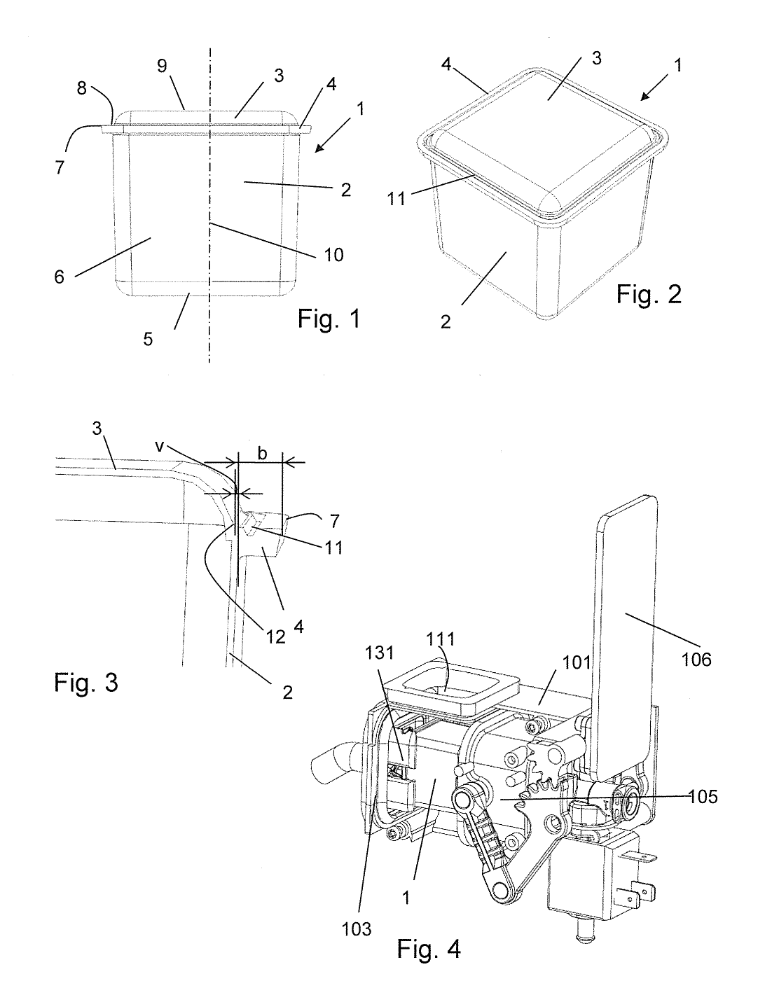

The capsule 1 according to FIGS. 1 and 2 and which is filled with an extraction material—in particular ground coffee—essentially has the shape of a cube with rounded edges. The expanse however increases slightly towards to side lying at the top, so that the capsule has a truncated pyramid shape in a strict mathematical sense. The inclination angle of the surfaces, which are lateral in the figure, with respect to the perpendicular to the bottom surface 5—what is meant of course is that plane that is perpendicular to the bottom surface and that runs through the edge between the bottom surface and the corresponding lateral surface—is very small and at the most is preferably 2°, for example only approx. 1°. Moreover, the height of the capsule above the bottom surface corresponds approximately to the length of the bottom surface edges.

The capsule includes a main body (or beaker) 2 and a cover 3 that is fastened thereon along a peripheral collar 4. The main body forms a capsule bottom 5 and a peripheral side wall 6 which, at its end which is at the outside with respect to the axial directions (axis 10) and which is at the top in the figure, is terminated by the collar 4. The cover is arched outwards, by way of the cover surface 9, which is essentially parallel to the capsule bottom 5 being offset outwards with respect to the peripheral collar 4. The capsule is arcuate in the transition region between the collar 4 and the cover surface 9, wherein here it is constantly arcuate from an outer portion, which is at an (almost right) angle to the collar plane, towards the middle flat region i.e. is primarily convexly curved.

The peripheral collar forms a surface 8 that faces the cover side and extends from the outer edge 7 of the collar up to the base 12 of the arching. FIG. 3 shows an enlarged detail of the capsule in a sectioned representation. The width b of the collar 4 is the distance of the outermost edge 7 of the collar to the outer side of the main body 2.

In the embodiment according to FIGS. 1-3, the base 12 is offset inwards with respect to the peripheral side wall that is formed by the main body 2. The offset v, as is illustrated in FIG. 3 is measured between

on the one hand the outer surface of the main body in the region of the collar 4,

and on the other hand the plane that is parallel to this and which goes through the location of maximal concave curvature in the transition between the surface 8 and the arching of the cover.

FIGS. 2 and 3 show a groove 11 in the region of the peripheral collar 4, in the surface 8. Such a groove can be present if the cover is manufactured by way of deep-drawing (or embossing) and an energy director 23 is present on the cover for welding the cover 3 to the main body 2. Such a groove is not present in other embodiments - for example if the energy director is not present on the cover or if the cover although having an energy director, is however manufactured by way of injection moulding.

The brewing module 4 according to FIG. 4 includes a brewing module housing 101 and, held or guided by the housing, a discharge device 103 as a first brewing module part, and an injector 105 as a second brewing module part. The injector 105 by way of an operating lever 106 can be moved relative to the housing and to the first brewing module part, between an open position in which the brewing chamber is open and the operating lever is at the top, and a closure position, in which the brewing chamber is closed and the operating lever is folded downwards. FIG. 4 shows the brewing module in the open position and with an inserted capsule 1. An insert opening 111, which also sets the orientation of the capsule on insertion, is present for the insertion of the capsule 1. The insert opening 111 also indicates the orientation of the capsule 1 that is to be selected, by way of indicating the position of the collar 4.

Lateral guide means 131—shaped as guide jaws—are present on the discharge device, and these guide the collar 4 of the capsule on insertion and hold the capsule in the desired position, when the brewing module is closed.

The already mentioned European patent application 13 186 920.8 and in particular its detailed explanations concerning the manner of functioning of the lateral guide means and the retrieval elements which are described there, is referred to with regard to the functioning manner of the brewing module. A feature of the capsule that is used for guidance on insertion, for holding in the insert position, and for ejecting the capsule after the brewing process with the help of the mentioned retrieval elements is the rectangular basic shape in the region of the collar 4, which permits a lateral guiding along an extended path along the capsule, as well as in some embodiments, also the engagement of the retrieval elements at a position along this path.

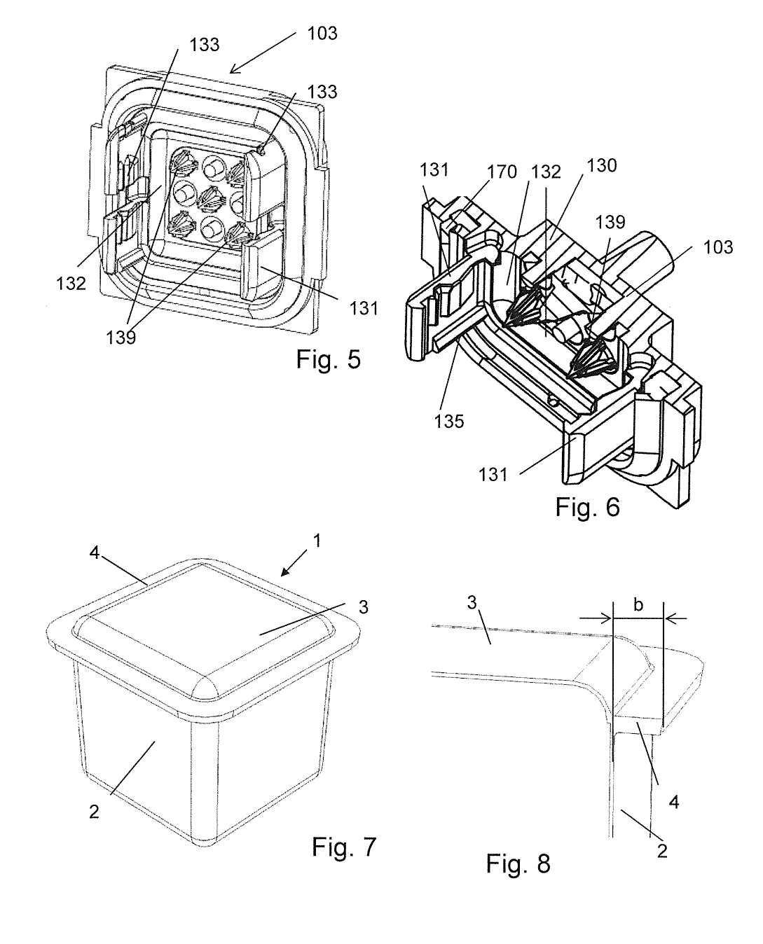

FIGS. 5 and 6 show the discharge device 103. On closure of the brewing chamber formed by the brewing module (by way of displacing the injector 105 towards the discharge device given an inserted capsule 1) and/or during the brewing process, the cover 3 is pierced by extraction-side perforation spikes 139, so that the extraction product can flow away out of the capsule through channels which are envisaged for this. The manner of functioning of the extraction spikes, which are shown here is described in the European patent application 13 185 359.0, but here, the described invention is independent of this functioning manner and can also be applied with other extraction devices.

A sealing of the capsule 1 with respect to the discharge device here functions without a separate extraction-side seal. Such a sealing is necessary, so that the brewed drink exiting from the capsules gets into the pour-out and cannot drop to the bottom past the capsule 1. For this purpose, a sealing surface 132, which is matched to the arching of the capsule cover 3 and is therefore at least partly concave, is present on the extraction side, against which sealing surface the capsule is pressed in an extensive manner during the extraction process. Thereby, this sealing surface can be manufactured of a hard material—for example injection-moulded hard plastic or metal—whereby it is the capsule wall which is deformable during the brewing process and is sealingly pressed against the sealing surface 132. The arching of the capsule cover and, entailed by this, the here concave curvature of the sealing surface 132 make a significant contribution to this sealing effect.

A closure seal 170, which here is designed as a lip seal, can be seen in FIG. 6. This seal bears on the housing of the injector 105 in the closed condition of the brewing chamber and is pressed against this when subjected to or impinged by pressure. This seals the brewing chamber and prevents the exit of water, even if—for example for a rinsing procedure—no capsule is inserted. This closure seal 170 however is of no significance with regard to the sealing of the capsule with respect to the brewing chamber and thus with the control of the extraction product flow.

FIGS. 7 and 8 yet show a variant of the capsule. In this variant, the capsule differs from the capsule according to FIG. 1-3 by two features that are independent of one another and can each be realised individually.

Firstly, the cover 3 of the capsule according to FIGS. 7 and 8 are not manufactured by way of deep-drawing or embossing, but by injection moulding. For this reason, a groove 11 is not necessarily formed at the outer side of the energy director.

Secondly, the capsule collar 4 has an even larger width b. This is approx. 4 mm in the case of a capsule diameter of roughly 27 mm. It has been found that the stiffness characteristics of the collar with a width b of between 1.6 mm and 4 mm, for some applications in particular between 1.6 mm and 3 mm, are particularly favourable, in order to have the required guiding characteristics, sealing characteristics and deformation characteristics.

Other capsule shapes are also conceivable. Thus, for example, one does not rule out the main body tapering conically to a greater extent and thus the capsule as a whole not being essentially cube-shaped, but having more the shape of a truncated pyramid, which is different to the represented embodiments. Transitions to more greatly rounded shapes towards the bottom or stepped shapes are also conceivable.

1. A portion capsule of plastic and filled with an extraction material, for creating a brewed product, said capsule comprising:
a main body with a bottom region and with a peripheral side wall; and
a cover, which is fastened on the main body;
wherein the cover is fastened on the main body along a peripheral collar, wherein the collar towards a cover side connects to the peripheral side wall;
wherein the main body in the region of the collar has an essentially rectangular cross section;
wherein the cover forms an outward arching, so that the cover contributes to a capsule volume;
wherein the collar has a width of at least 1.6 mm.

2. The capsule according to claim 1, wherein the collar width is between 1.6 mm and 2.2 mm.

3. The capsule according to claim 1, wherein the main body and the cover are manufactured from the same plastic material.

4. The capsule according to claim 3, wherein the main body as well as the cover are manufactured of polypropylene.

5. The capsule according to claim 1, wherein the cover from an outside to an inside comprises a collar region forming a surface facing the cover side, an arcuate transition region and a flat region, which is set away from a plane of the surface.

6. The capsule according to claim 5, wherein the flat region assumes at least 40% of a cover surface.

7. The capsule according to claim 1, which, with the exception of the collar is cube-shaped or cuboid.

8. The capsule according to claim 1, wherein a base of the arching is offset inwards in comparison to the portion of the side wall, onto which portion the collar connects.

9. The capsule according to claim 1, wherein the cover is provided with an energy director.

10. The capsule according to claim 1, wherein the main body can be bloated by way of the introduced brewing fluid, in a manner such that a capsule diameter increases by at least 1 mm at a brewing fluid temperature of 95° C. and an overpressure of 1 bar, inasmuch as no mechanical hindrances oppose such a bloating.

11. A system for preparing a brewed product, comprising a capsule according to claim 1, as well as a machine with a brewing module for forming a brewing chamber receiving the capsule, said brewing module comprising an injector for introducing a brewing fluid into the capsule, and a discharge device for the-discharge of the brewed product out of the capsule, wherein the discharge device is provided with a sealing surface that is matched to the arching and against which the cover of the capsule inserted into the brewing chamber is pressed under the pressure of the brewing fluid.

12. The system according to claim 11, further comprising a lateral guide for guiding the collar during the insertion of the capsule into the brewing module.

13. The system according to claim 11, wherein the injector comprises at least one capsule seal, which has a peripheral sealing feature that presses the peripheral side wall of the capsule inwards during the brewing procedure.

14. The system according to claim 11, wherein an insert opening and a guide position the capsule such that the cover of the inserted capsule lies on the side which is to the discharge device.
